(19) United States
(12) Patent Application Publication
(10) Pub. No.: US 2014/0244476 A1
(43) Pub. Date: Aug. 28, 2014

(54) CONTINUOUS DIALOG TO REDUCE CREDIT RISKS

(71) Applicants: Simon Shvarts, San Jose, CA (US); Evgeniya Kuyda, Moscow (RU)

(72) Inventors: Simon Shvarts, San Jose, CA (US); Evgeniya Kuyda, Moscow (RU)

(73) Assignee: RAWLLIN INTERNATIONAL INC., Tortola (VG)

(21) Appl. No.: 13/777,986

(22) Filed: Feb. 26, 2013

(51) Int. Cl. G06Q 40/02

(52) U.S. Cl. CPC G06Q 40/025
USPC 705/38

(57) ABSTRACT

A financial interaction related to personal data analytics and behavioral data is facilitated. The financial interaction drives behaviors to affect a real-time credit risk, and provides direct feedback during the financial interaction. The system operates as a personal companion for assisting clients with personal financial decisions as well as personal interactions according to personal data and behavioral data learned about the user. Communications from the system can be initiated to facilitate a conversation according to data learned, such as personal data, user preference data, and behavioral data from different financial transactions. Based on continued interactions with the user, estimates can be made of a financial score and rewards or stimulus can be presented to the user.

### CROSS-REFERENCE TO RELATED APPLICATIONS

The subject patent application is related to co-pending U.S. patent application Ser. No. 13/615,053, filed on Sep. 13, 2012, entitled “Behavioral Based Score,” which is hereby incorporated by reference in its entirety.

### TECHNICAL FIELD

The subject application relates to observing behaviors and interpreting the behaviors to generate a behavioral based score.

### BACKGROUND

A number of consumers have experience with short term loans, payday advances, cash advances, and financial options throughout everyday life. These types of financial dealings and instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives to borrowing from pawn shops, friends, or family, or obtaining advice on financial decisions. In addition, a lack of financial knowledge can worsen a person's financial condition.

Additionally, consumers are frequently presented with opportunities to apply for instant approval for credit cards during internet shopping, or at the point of sale during traditional in-store shopping. Often, the consumer can charge a current purchase to the new account if they are approved, and may be able to take advantage of one or more promotions for applying. However, consumers having little, or no, credit history are unlikely to be approved for these credit cards, such as with college students trying to start careers for the first time or groups of elderly always wary of credit. In addition, some consumers choose not to use credit cards, or elect not to go through the application process at the time that the offer is presented. Moreover, retailers often attempt to persuade consumers to purchase additional items, or items related to what the consumer is purchasing, as well as financing options and the like, which may not be optimal for the consumer.

The above-described deficiencies of today's credit application and promotional tools lend for the need to better serve and target potential clients. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments are disclosed that provide a dynamic personal companions via one or more computing devices through knowledge learned from communications with a user device or personal digital device. In one embodiment, a system is disclosed that comprises a memory that stores computer-executable components and a processor, communicatively coupled to the memory that facilitates execution of the computer-executable components. The computer-executable components include an interaction component configured to facilitate a communication with a set of dialogues based on a set of personal data analytics and a set of financial behavioral data. A personal data component is configured to determine the set of personal data analytics based on a set of inputs that relate to financial data identified at a user device. A behavior component is configured to determine the set of financial behavioral data based on a set of financial transactions with the user device.

In another embodiment, an apparatus comprises a memory to store computer-executable instructions and a processor, communicatively coupled to the memory, that facilitates execution of the computer-executable instructions. The computer-executable instructions at least facilitate a conversational dialogue by communicating a first set of dialogues, determine a set of personal data analytics based on a set of inputs received from the conversational dialogue that relate to communicated personal data or personal data identified from a data store, determine a set of behavioral data based on a transaction or exchange of assets detected, and communicate a second set of dialogues for the conversational dialogue based on at least one of the set of personal data analytics or the set of behavioral data.

In another embodiment, a method comprises determining, by a system including at least one processor, a set of personal data analytics. A set of behavioral data is determined based on one or more financial transactions, and a conversational exchange is facilitated based on the determined set of personal data analytics and the set of behavioral data.

In another embodiment, a tangible computer readable storage medium comprising computer executable instructions that, in response to execution, cause a computing system to perform operations. The operations include facilitating a first conversational exchange with a first set of financially related communications. A set of personal data analytics is determined based on a user profile, and a set of behavior data is determined based on a financial transaction identified. Financial assistance is communicated in a second conversational exchange based on the determined set of personal data analytics and the set of behavior data.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system for providing dynamic financial assistance in accordance with various aspects described herein;

FIG. 2 illustrates another example system in accordance with various aspects described herein;

FIG. 3 illustrates another example system in accordance with various aspects described herein;

FIG. 4 illustrates an example index component in accordance with various aspects described herein;

FIG. 5 illustrates an example system in accordance with various aspects described herein;

FIG. 6 illustrates an example recommendation component in accordance with various aspects described herein;

FIG. 7 illustrates a flow diagram showing an exemplary non-limiting implementation for a system in accordance with various aspects described herein;

FIG. 8 illustrates a flow diagram showing an exemplary non-limiting implementation for a system in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. In addition, the term “set” refers to “one or more.”

### Overview

In consideration of the above-described deficiencies among other things, various embodiments are provided that financially assist and interpret data related to clients for credit worthiness, and, more generally, is related to facilitating and observing a set of financial interactions, such as dialogues, conversations, and/or, in other words, exchanges based on a user's behavior and personal data analytics. The set of financial behaviors can include a person's risk tolerance level, spending habits, goal setting, saving habits, payment history, financial attitudes towards each, and/or other behavioral indicators that relate to financial behaviors, financial habits, financial beliefs, and/or financial attitudes of a person's mindset. In addition, communications with the client or customer is based on personal data analytics, or, in other words, personal analytic data that is obtained from a user profile, a psychological profile of a user, data stores, conversational exchanges, dialogues that dynamically get to know a user and provide needed financial assistance on investment, savings, payment plans, and the like.

In one example, a financial interaction, communication and/or dialogue is facilitated by an interaction component in response to the actual financial behavior (recent transactions, savings, debits and credits, rent, etc.) of a user as well as personal data analytics. The communication content can be based on one or more financial behaviors and/or personal data analytics, which can be determined and communicated in a manner that corresponds to a set of user preferences. The financial interaction is thus facilitated according to the transactional behavior data, personal data analytics and/or user preferences, which can include responses having recommendations provided to the user, in response to financial decisions observed, information learned about the user such as classifications of a user's psychology and/or data from a user profile. A user's behavior, for example, can be tracked via communications with a transactional database or system component (e.g., a digital wallet, bank account aggregators, etc.), through a direct conversation with the user and a personal digital device (e.g., a mobile device). In one example, the system can recommend to reduce spending in a particular category, further communication can then be generated and a financial score determined based on how the user behaves in response to the recommendation and/or according to the personal data identified, behavioral data and/or user preferences. The behavioral data, personal data analytics and/or the user preferences can be observed, learned and/or predetermined by a user device (e.g., a mobile phone, personal device and the like) having the interaction component. Thus, the user device can operate as a personal companion for financial assistance and as a means to provide reward or stimulus to the user.

In one embodiment, a financial measure of a client can be determined with the interaction component of a system or device for a small loan, a large loan or some other financial instrument, information pertaining to the client is obtained by facilitating a financial interaction, such as an exchange, a dialogue, and/or a conversation that can be initiated with statements, questions, recommendations and/or determinations as to how the user acts upon the recommendations. A set of behaviors can include, for example, beliefs, actions related to various stimuli (e.g., better credit offers, improved credit rating options, savings tips, etc.), reward stimulus, inputs, responses and/or the like. Behavioral data can be ascertained from information (personal, financial behavioral, etc.) that is identified throughout the financial interaction with a client. The data can be used to determine a set of financial scores that are displayed from, during and/or throughout the interaction.

### Continuous Dialog to Reduce Credit Risks

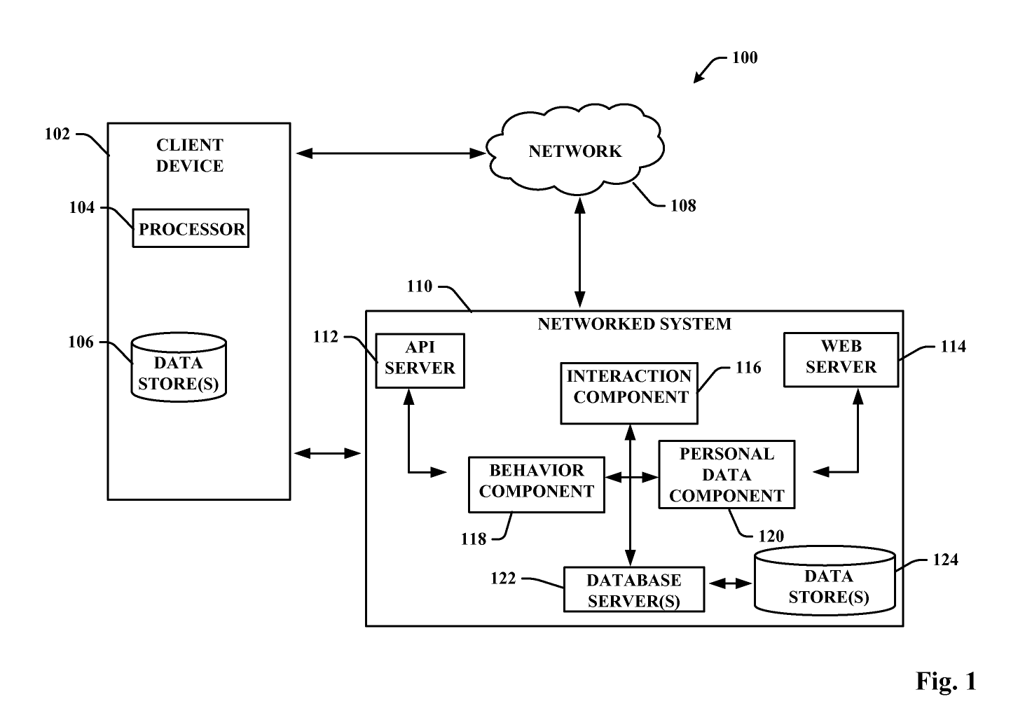

Referring initially to FIG. 1, illustrated is an example system 100 to output one or more recommendations pertaining to a client in accordance with various aspects described herein. The system 100 is operable as a system to converse with a client as a friend, associate or counselor (e.g., a financial assistant) in a continuous manner by continuously learning about the client and client behavior, and further dialoguing with the client based on the knowledge learned on a periodic basis or on behavioral identifications. The system 100 can operate, for example, to recommend ways to increase a financial measure (e.g., a financial score), to improve financial behavior that is related to (e.g., financial goals, spending behavior, financial condition, investment recommendations, savings, credit, payment, etc.), to recommend credit to potential clients, provide recommendations to third parties such as marketing strategies based on the set of behaviors (e.g., set of beliefs, habits, tendencies, characteristics indicating behaviors, etc.) observed, and/or provide other assistance in other personal areas and transactions. The system can provide recommendations and dialogue based on analysis of a dynamically and iteratively generated set of dialogues and/or behaviors detected during financial interactions (e.g., conversations, a set of exchanges, and/or other such interaction related to a set of financial behaviors by a user or client of the system).

The system 100 includes a client device 102 that comprises a computing device, a mobile device and/or a mobile phone that is operable to communicate one or more messages via an electronic digital message (e.g., a text message, a multimedia text message, and the like) and/or a voice message with an audio output/input (e.g., speaker, microphone, etc.). The client device 102 includes a processor 104 and at least one data store 106 that processes and stores exchanges of a financial interaction (e.g., a set of conversations, exchanges, and/or interactions) as well as personal data analytics related to the client or user. The exchanges or behaviors observed can include a number of responses or behaviors of the client that can be generated and/or tracked from among one or more devices. For example, a set of dialogues, recommendations and/or a suggestions can be provided to a client that can include a set of questions, a set of answers, a set of statements, a set of declarations, a set of data, etc., that are exchanged during the interaction, and based on the responses and/or financial behaviors by the user, the system 100 can determine and/or update a financial measure score.

The client device 102 is operable to communicate multimedia content via the network 108, which can include a cellular network, a wide area network, local area network, and/or other type network. The client device 102 is further operable to communicate to other devices or systems, such as to a network system 110 via a network 108. The network 108 can also include a cloud network that enables the delivery of computing and/or storage capacity as a service to a community of end-recipients that entrusts services with a user's data, software and computation over a network. Additionally, the client device 102 can include multiple client devices, in which end users access cloud-based applications through a web browser, a light-weight desktop or mobile app and to resources of the networked system 110.

The system 100 includes the networked system 110 that is communicatively connected to one or more servers and/or client devices via the network 108 for receiving user input, gathering personal data in a user profile, identifying financial transactions by the user, and communicating with the client through a financial conversation or financial dialogue exchange. The network 108 is communicatively connected to the networked system 110, which is operable as a networked host to provide, generate and/or enable message generation on the network 108 and/or the client device 102 either directly or via the network 108. The networked system 110 includes an application programming interface (API) server, in which the client device 102 and/or other client device, for example, can requests various system functions by calling one or more APIs residing on the API server 112 for invoking a particular set of rules (code) and specifications that various computer programs interpret to communicate with each other. The API server 112 operates with a web server 114 to serve as an interface between different software programs, the client machines, third party servers and other devices. For example, the API server 112 and/or the web server 114 facilitate interaction with a client or customer via an interaction component 116, a behavior component 118, and a personal data component 120, as well as with other various components, in which each have applications for hardware and/or software.

The networked system 110 can further include a database server 122 that is communicatively coupled to one or more data stores 124, such as public and/or private networked data stores, which include telephone data stores, banking data stores, social networks, and the like. The database server 122 can collect data related to the client for a user profile to be generated from data gathered from the one or more data stores 124 and from observational data identified from conversations with the client with the system 110 and from data related to various described components and systems described herein, such as questions, scenarios, recommendations, a set of key indicators that can be indexed, stored and classified to correspond with a set of inputs (e.g., such for psychological profiles of the client), as well as other data for determining a financial scores via a financial interaction.

The network system 110 having the interaction component 116, the behavior component 118 and the personal data component 120, is configured to facilitate, analyze and generate feedback during a financial interaction with a client and continuously provide feedback over various periods of time. The network system 110 thus enables a user to establish and define a relationship with a digital assistant such as the system 110 by providing interaction back and forth based on one or more user defined preferences, personal data analytics and identified behavior data. The interaction component 116 is configured, for example, to facilitate dialogue or conversation, such as a financial interaction to the client device 102. The financial interaction that is facilitated is based on communication exchanges, personal data, user preferences, and/or financial behaviors, such as whether the client or user follows advice or recommendations that are provided, a transaction that is being undertaken, past financial transactions, financial terms, product availability, financial status, etc., and information as it is learned, received or identified about the user. For example, the networked system 110 via the interaction component 116 can generate a set of dialogues, recommendations and/or suggestions that facilitate a conversation, otherwise known as a financial interaction, dialogue or exchange, which is related to financial behaviors of the user. The dialogue generated can be between the network system 110 and the client device 102, and/or only with the user device or networked system, in which interaction can occur between at least one user and with the interaction component 116. The interaction component 116 can facilitate dialogue through various means or multiple channels, such as a voice generated interaction, key pad interaction, chat interaction, iMessage, video (e.g., for sign language communication and the like) and/or interaction with various forms, questionnaires, responses, recommendations, etc., in which advice or suggestions provided to the client are then tracked, such as via a digital wallet, bank account aggregators, and other such information sources of financial data related to the client's behavior as discussed above.

In one example, a user interacts with the networked system 110 via the client device 102 through one or more channels for a conversation or voice exchange such as iMessage, voice exchange as operated by the interaction component 116. The interaction component 116 can dynamically respond to various responses, answers, statements, actual financial behavior, such as recent transactions, savings, debits and credits, rent payments and any other such financial related behavior associated with the client via the client device 102. The responses from the interaction component 116 can be recommendations or advice that includes options for improving the client's financial condition, statements, and/or questions to initiate a response or further conversation about the client or user's financial knowledge, condition, personality, user preferences and the like. For example, a question could be provided that is a closed ended question (e.g., eliciting yes or no answers), such as “Would you like to determine a financial score for yourself, receive education or financial knowledge, a lower interest rate on a credit card, and/or register for auto-pay for one or more bills?” Other types of questions or options could also be provided to provide a set of financial recommendations, to indicate a user's behavior in response to the recommendations, collect data about preferences and/or personal data analytics.

In on embodiment, the interaction component 116 operates to converse, exchange and/or initiate dialogue with a client based on one or more user preferences, such as a tone (e.g., a voice tone, text language tone), a language, a gender, a voice (e.g., celebrity voice or other voice), a dialect and/or a grammar construction. A user can set the user preferences and the user preferences can be changed based on circumstances and data gathered from personal data analytics and personal behaviors identified. For example, where the user opens up an investment account, the interaction component 116 can operate to provide investment advice, knowledge about investment decisions, and/or other financial data based on the users income, interest, savings, and the like data about a financial condition of the user.

Based on how the user follows a recommendation, suggestion, responds in conversation to questions, and/or advice, the system 100 is configured to determine a financial measure to dynamically rate and present the measure to the client. For example, the financial measure can be a score. In addition, the interaction component 116 can provide options or recommendations in response to questions, such as open or closed ended questions, scenario options, data fields, etc., to further facilitate an interaction about a client's finances and “get to know” or ascertain knowledge of a financial and personal nature as a companion. For example, a question such as “Would the client like to provide savings in a savings account?”, “From what account would the client like to transfer money to a savings account?”, “What frequency would the client like to transfer money to a savings account?” and other such financially related questions or options could be generated by the interaction component 116. Because behaviors, such as a client's financial behavior, can be a product of various beliefs, habits, and experiences, as well as abilities and means, the interaction is facilitated to gauge these sets of behaviors from personal data analytics and of the client's behavior. For example, a user profile or psychological profile that includes various classifications to categorize and understand a user's behaviors can be stored and dynamically generated over time. From the user profile, a personal data component 120 can determine personal data analytics that tell information about a user's interest, preference, savings, spending and/or investment habits, whether the user is likely to deviate, risk tolerance for the user, as well as deviated behaviors or ways to stabilized behavior through increased knowledge. Once an overall profile or assessment is generated about a client's financial behavior, recommendations or advice can be further given for modifying the behavior, and a financial measure or score can be determined.

The behavior component 118 is configured to analyze the data obtained from the client device 102, a data store (e.g., data store 124) and/or some other device, component, network or system (e.g., a digital wallet, bank account aggregators, and the like). The behavior component 118 is configured to identify and/or determine financial behavior data from various data stores, conversational exchanges, and/or transaction data from financial transactions in order to determine various data indications of the client's behaviors and/or likes, dislikes, and/or general profile. The data can be a set of behavioral indicators related to the client's financial behavior, which can be used by the interaction component to make an assessment or objective measure of the client's behavior and/or personality.

The system 100 includes a personal data component 120 that operates with the behavior component 118 to enable the interaction component 116 to dynamically dialogue and provide financial feedback, knowledge and assistance to a consumer. The personal data component 120, for example, is configured to determine personal data analytics or personal analytic data based on inputs related to financial data identified through conversation via the user device with the client, through user profiles in data stores and/or from data collected about the user's behaviors and/or interactions with other parties via the network 108.

The financial behavior data and the personal data analytics can thus provide information, data or evidence that the client has, has not or in what manner the client has acted, is acting or will possibly act in accord with sound or healthy finances. For example, the set of behaviors can include skills, abilities, beliefs, knowledge, and the like for the client to have sound or healthy financial behavior. Personal data analytics can therefore be indications, probabilities, and/or classification that are negative, positive, or neutral, and can be used to provide a financial score or to measure the client's credit worthiness based on the financial score as well as indications of how a user will respond and what information could be pertinent to the user's financial condition for interactive dialoguing.

For example, if the networked system 110 can assess the responses provided by the client device 102 for competence to “make payments well,” “to save” etc., the behavior component 118 compares responses received from the client device 102 to an index of possible positive or negative key indicators (e.g., financial behavioral data, personal data analytics, user preferences, etc.) for competency in making payments well, saving, etc. An example of positive behavioral data can be a probability that the client makes payment obligations each month, pays obligations on time, does not get behind on payments, pays bills immediately, pays entire balance to avoid interest each month, has a predetermined number of bills that are paid (e.g., at least four, and under ten bills), as well as other such financial indications or indicators of various financial conditions, which can also be related to the behavioral criteria of the recommendations, suggestions and/or advice given to the client.

Negative indicators that can be related to a competency for “making payment well” that are analyzed by the behavior component 118 could be the opposite of the positive data, and also include other indications such as having too many or very few bills to pay. Making a minimum payment only could be a neutral indicator that could elicit a recommendation to double payments with a calculated amount of interest that would be saved to the client device 102. No one indicator or set of indicators are fixed, and any number of indicators related to financial conditions or states of behavior are envisioned to be utilized by the networked system 110.

In another example, the behavior component 118 can measure competencies for saving, with personal data analytics that indicate such financial conditions as having a savings account, a percentage of savings being established, and/or a desire to save as indicated by answers to questions involving open ended, closed ended and/or scenario questions, and/or as indicated by tracking of a digital wallet, a bank aggregator or some other financial transaction system that tracks the user's financial behavior, and the like. Various data, such as behavioral data analyzed according to probabilities, personality profiles (e.g., Myers Briggs, etc.), psychological profiles and personal data that classifies individuals can be useful to indicate a client's behavior (past, present and future). Scenario questions could be dynamically generated to include certain aspects or topics that a person likes, such as video games, cars, food, etc., which could be presented to the client as part of a financial scenario with choices to purchase one of these likes that are new and available as opposed to more frugal options, such as increasing savings or saving for education. This is only one example way of initiating conversation via the interaction component 116 of the networked system 110, in which various processes can be used with different data from user preference data, behavioral data of a client, personal analytic data and the like for continuing an ongoing conversation related to finances with a client through or with the components of a system, device, or personal digital assistant.

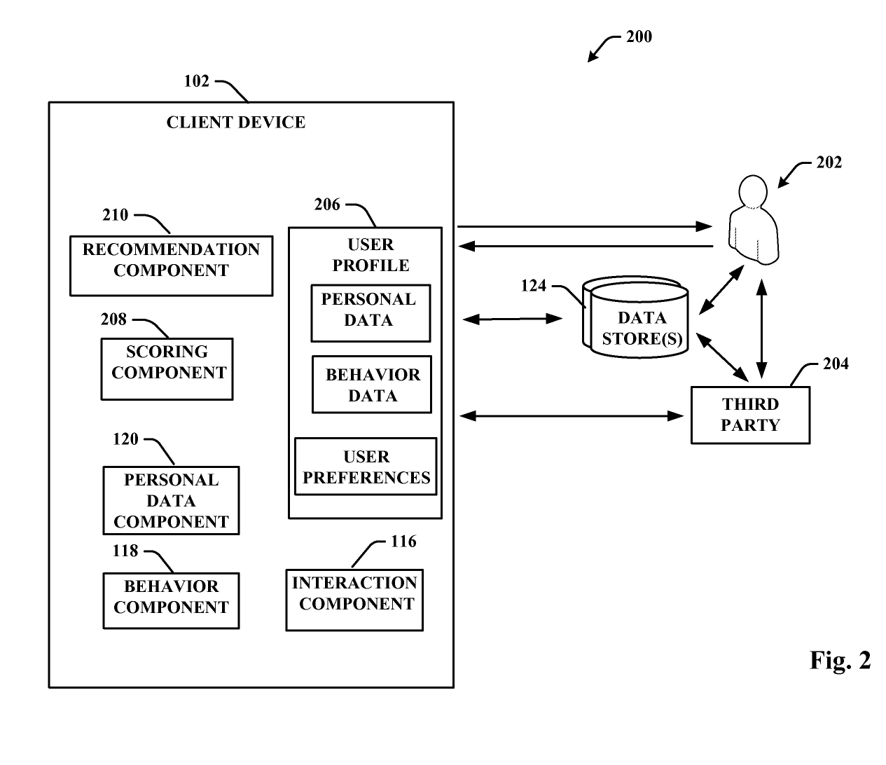

Referring now to FIG. 2, illustrated is another example system 200 that includes the client device 102 for interactive financial guidance and companionship of financial matters in accordance with various embodiments described. Various competencies can be analyzed during a dialogue, interactive conversation, and/or exchange between the client device 102 and inputs received from a user 202, for example. The client device 102 operates to initiate and engage in conversation by provided feedback via voice, text, messaging, video, etc. via the interaction component 116 and based on personal data analytics ascertained by the personal data component 120 and behavioral data via the behavior component 118. The client device further includes a scoring component 208 and a recommendation component 210.

The scoring component 208 is configured to generate a financial score that can be updated dynamically or in real time during the financial interaction as different indicators of the client's behavior toward finances are analyzed and ascertained. The analysis of the behaviors and personal data can be based on a set of inputs received during a conversational exchange, financial transaction conducted with the client device, stored in one or more data stores (e.g., such as a user's information, personal data, networking sites, social sites, third party data stores, which the users has enabled access to for a more personal digital financial companion. The personal data component 120 can analyze various competencies, behavioral probabilities, profiles, classification of the user's likes/dislikes and/or user preferences. For example, various behavioral criteria can include a matching of indications of different types of financial conditions and/or behaviors that are weighted to a score in an index stored in a data store (e.g., data store 124), such as having a savings account, desire to open a savings account, desire and ability to save, choosing to save over choosing to spend on a desired item when confronted with different financial scenarios (not paying bills, paying for education, etc.). Indicators for each of these criteria can be first elicited through the facilitated financial interaction in the form of recommendations, suggestions or advices that can include questions, open ended or closed ended questions, scenarios, and/or statements that can be rated on a predefined scale according to how the client follows the advice provided by the recommendation component 210 or what options the client follows or behaves according to.

For example, the behavior component 118 can detect that the user exchanges currency while traveling and detects that the conversion rate was not good. The interaction component 116 can then recommend to the user to exchange his currency at a different place. If indications are detected that the user ignored the advice, the system 100 can then downgrade the user's score. In another example, the behavior component 118 can detect that the user did not pay his credit card balance in full and thus will need to pay a higher interest rate. The system 100 via the interaction component 116 can inform the client (e.g., the client device 102) and ask the client if he wants to be reminded next time, as well as provide further options such as setting up autopay and/or other financial recommendations. According, to the client's behavior, a financial score can be upgraded or downgraded. For example, if the client follows the advice, his score can be upgraded based on how the client responds and/or to what advice the client follows or does not follow.

In one embodiment, the data provided by the client, ascertained by the behavior component 118 and/or personal data component 120 can be looked up in an index and matched for a weighted measure or score that contribute to the financial score or credit worthiness score, and/or be used to modify a set of user preferences including a tone, a language, a gender, a voice, a dialogue, a grammar construction, a point of interest, educational knowledge, and/or guidance toward more education of a financial situation, personal situation or other such circumstance in which a user could find himself or herself. The scoring component 208 is configured to generate a financial score based on the set of key indicators of financial behavior, such as did the client follow a recommendation or not, or follow some other course of action that demonstrates sound or healthy financial responsibility or some other activity other than financially related activities.

In one embodiment, the scoring component 208 can be used to alter, modify and/or initiate various communications in different manner of user preferences or classifications in order to communicate a subject matter to the user via the client device 102. As such, the client device learns and adapts to different user circumstances and can alter a financial score that can be used to help the user financially, aid the user as a companion, present the score to the user, and/or used for altering the dialogue via the manner in which the dialogue is outputted to the user (e.g., a different tone, a different dialect, grammar construct, etc.). Data stores and/or sources of data can be gleaned or identified from conversational data, personal data stores, and/or interaction with a third party 204. Additionally, the scoring or measure determined via the scoring component 208 can enable the interaction component 116 to alter a subject matter that a conversation initiates about from the client device 102 based on the information obtained from personal data analytics, behavioral data, and/or user preference data.

The financial score for example can be a combination of scores that correspond to one or more indicators or portions of data from behaviors, conversations, transactions, user defined preferences, etc. For example, the scores can be summed together and weighted based on other indicators and/or based on the number of other categories of indicators that have been determined. Throughout the financial interaction, as more indicators for various types of financial related behaviors/competencies are determined, the score can be altered and dynamically generated by the scoring component. Thus, the client device 102 is able to view or receive a financial score throughout the financial interaction to show how behavior and/or behavior changes influence financial health or overall for assisting the client in various circumstances whether financial in nature, or in other situations that may involve safety or some other decision making situation that the client device adapts to interactively with the user 202.

The recommendation component 210 of the computer device 302 is configured to generate advice content related to behavioral responses received or detected during the financial interaction based on the set of key indicators. For example, advice on spending with different consequences that affect the financial score from the scoring component 120 can be provided by the recommendation component 210 in response to input received during the conversation, interaction and/or transaction with a third party 204. For example, a conversation or a portion of the financial interaction can occur with the interaction component 116 and user that could include the subject of savings, and be based and adapted on the responses received. The recommendation component 210 can generate a list of ways to save that can be elaborated on according to further inputs received or an updated financial condition (e.g., updated behavioral data related to finances, a transaction, personal activity, personal profile data obtained, etc.). A question could be provided, for example, whether the client believes saving is a top priority or goal, and a “yes” answer to setting up a savings account or other type savings account could incrementally raise the financial score of the client as dynamically displayed. In response to the yes, the client device 102 could inquire further into what the client would like to save for. If the answer is beer this weekend, or some other short term benefit, a decrement to the user's score could be attributed to the score as a result of the behavior of uncontrolled delayed gratification associated with finances. A more long term savings plan would hint towards a more long term thinking client, which would be better prepared to invest money with, such as for a loan or the like. A series or set of behaviors determined provide a more accurate financial score.

Additionally, the feedback component 210 is configured to generate warnings that a certain type of move could detrimentally affect the financial score, in response to the score being lowered by a response that is a predefined difference. For example, in response to the client indicating that he or she would like to mortgage their home under an 80/20 loan/principal ratio, the system could generate that this would drop their financial score from 600 to 500, or some other difference in a range of scores.

A financial risk can further be determined via the client device 102 and shared with a third party 204, the user 202 and/or used by the interaction component to provide a reward stimulus to the user. An advantage of assessing financial risk or recommendation for credit on publicly available data in addition to privately held data is providing wider latitude to consumers needing such instruments. In particular, small business loans can be based on factors that do not require strict criteria, but can be assessed more heavily based on a person's behavior and behavioral modifications, which is ascertained from financial interactions with the customer.

In one embodiment, the financial scores can be determined from a combination of predefined scores matching different financial conditions, which can be already weighted. For example, rating a behavior that indicates a low belief in saving money can be set to indicate a low financial score. The financial score can be based on a scale that can be similar to the scale for a credit score or can be based on a different range of numbers, which can have various ranges therein corresponding to excellent, good, mediocre, bad and/or terrible financial behavior. The scoring component 120 is operable to determine and provide to the client device 102 a score based on one indicator and an updated score based on other indicators that are determined throughout the financial interaction.

In one embodiment, the networked system 110 is operable to interpolate the financial score where an indicator is provided of financial condition and there is no matching score within an index for a particular indicator. For example, where a client provides input indicating a desire to save, but the client provides a mixed answer where either conflicting indicators are provided or there is no score indexed to the indicator, then the financial score can be interpolated. For example, the scoring component 120 can use a different formula where a response in the financial interaction has too many indictors, conflicting indicators, and/or indicators not matching an indexed score. Rather than adding scores, or sampling matching indexed scores, the scoring component 120 can define a financial score based on the nearest indexed score in the index within a predetermined distance. For example, if a strong desire to save is indicated, but a lack of an ability to save is determined from the responses or behaviors detected, a score could interpolate the strength of the ability as being between the scores for a strong desire and a mediocre desire. Other methods of interpolation can also be used to determine indications of behavior that are not indexed with a matching score such as piecewise constant interpolation, linear interpolation, polynomial interpolation, and other forms of interpolation. This further enables a more dynamic analysis and keeps financial scores related to as many responses as possible during the financial interaction.

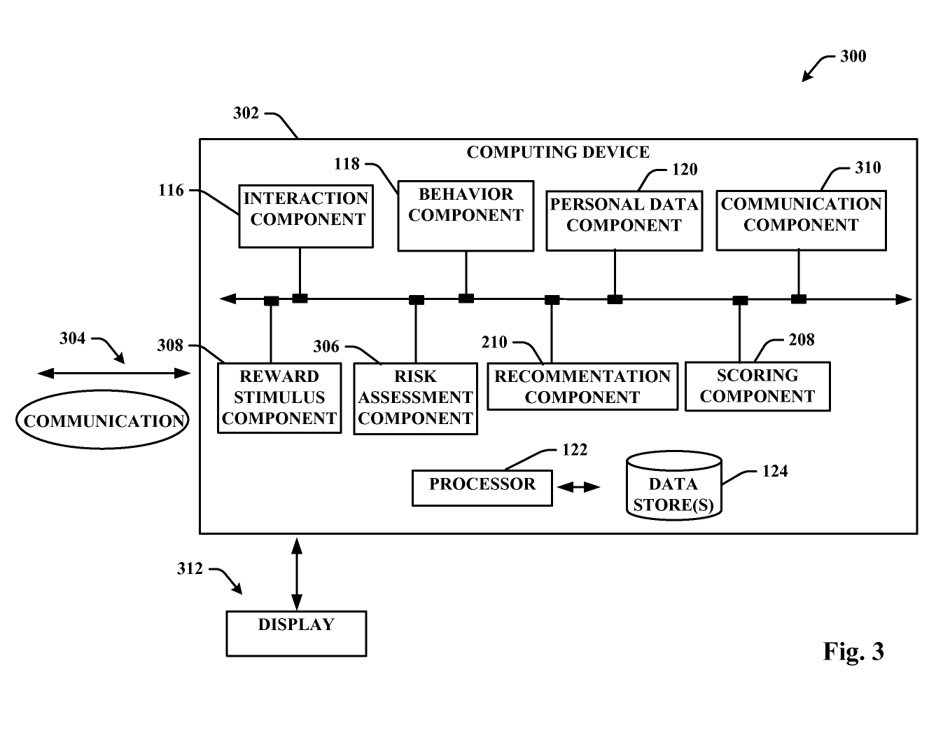

Referring now to FIG. 3, illustrated is a system 300 that facilitates a financial interaction 304 as a companion for user of a computing device 302 in accordance with various embodiments disclosed. By assisting a user conversationally in a continuous manner through a personal digital companion via the computing device 302, for example, financial institutions can further reduce risks associated with personal credit and have an ongoing programmed conversation to educate, understand and market to a user. The computing device 302 generates conversation through a digital voice companion via the interaction component 116 by using proper behavioral data, personal analytic data and/or reward stimulus via a reward stimulus component 308 and risk assessment component 306. The computing device 302 further includes a communication component 310 that can receive inputs (voice, text, and/or video) and communicate communications with a speaker, microphone or other like mechanism.

The computing device 302 is operable to receive inputs during and from a conversation, exchange and/or, in other words, a financial interaction 304 related to a set of financial behaviors. The financial interaction 304, as discussed herein, can be a conversation that is carried out live via text, instant messaging, voice over telephone, and the like, in which the voice input from a client on a client device (e.g., mobile device, phone, computing device, etc.) is converted to words and/or phrases in text by the dialogue component 116 and/or analyzed for indicators of behavior by the behavioral analysis component 118. Additionally or alternatively, the interaction 304 between client device and the computing device 302 can be via a text exchange, instant messaging exchange, or any conversational dialogue that includes data being exchanged, in which a second data is in response to a first data and so on. The financial interaction 304 is a dynamic interaction that is continuous during a user session comprising a plurality responses and exchanges with the computing device 302, which is operationally similar to the networked device 110 discussed above, and/or the client device 102, which can include a mobile phone, a computing device, a mobile device, a handheld device and the like device operable to interact directly with the client rather than via a different client device. The financial interaction 304 facilitated by the interaction component 116 to drive and continue conversation, exchange, or, in other words, dialogue regarding a set of financial behaviors based on user responses, such as behavior in accordance with recommendations or not. The dialogue component 116 can alter conversational exchange towards a user interest in order to drive conversation towards areas of concern, or where improvement in a financial condition could be. For example, an initiated conversational dialogue could respond to a circumstance or context in which the user is in with a question, statement and/or advice. For example, a conversation could transpire with the computing device 302 about home ownership in which the device 302 could get a response about savings. The interaction component 116 can begin exchanges about savings by questioning the user if he or she would like to interact about savings first or another topic for evaluating a financial score.

Financial behavior data gathered by the behavior component 118 can include any number of financial conditions, in which a client can provide response to and/or about via an answer, a closed ended statement (yes, no), a declarative statement of fact and the like. The responses could be indexed into various financial conditions based on key indicators, which can be behavior data including words, phrases in audio and/or text that include a statement or indication of a belief or tendency to adhere to at least one financial condition indexed as well as tracked or detected behaviors as to whether recommendations were followed. The words and/or phrases are evaluated by the behavior component 118 for indicators of financial conditions, which can be indexed or stored. The words and/or phrases, for example, can be in response to or selections to follow or not the recommendations provided to the user.

The computing device 302 via the scoring component 208 generates a display 312 of the various topics discussed during the financial interactions, as well as an ongoing financial score that gets updated, altered or modified during the financial interaction based on the set of behaviors determined during the course of the interaction. For example, the behavioral analysis component 118 determines indicators, such as detected behaviors, words or phrases that indicate a behavior to a recommendation, an interaction or financial transaction and updated personal data retrieved about the client (e.g., mood, an interest or other indication of the user). The data determined can provide indications of the set of beliefs related to the financial interactions 304. The data gathered can be used to determine a score, such as a financial score during the financial interaction 304, which is dynamically displayed throughout the interaction in the display 306 for a user to observe, later provided to show increases or decreases, and/or provided to third party at the user's request or authorization for reward. The display 312 can be a touch screen display for selections to be received via a touch, and/or any type of display communicatively coupled to the computing device 302 or to an external device that is in communication with the computing device 302.

The computing device 302 includes the risk assessment component 306 that is configured to determine a correlation between the set of data (personal data analytics, user profile) and a plurality of financial behaviors external to the facilitated financial interaction, and to determine a set of credit worthiness indicators based on the correlation. For example, the set of credit worthiness indicators can include at least one of an interest rate or a credit worthiness score, such as a credit rating or credit risk indication. In other words, the amount of correlation (e.g., a correlation degree) between the financial scores determined from the financial interactions and actual behaviors determined from actual credit data, payments history, credit history, etc., for example, can be factored into determining a credit worthiness score for giving a loan recommendation or other financial instrument. Various data sources, including the data store 124 and other internal and external data stores, can be employed for determining the credit worthiness, such as credit reports, or agencies/bureaus with private data pertaining to the client's credit score rating (e.g., TransUnion, Equifax, and Experion). Information about the client is searched with key search words (e.g., name, data of birth, email addresses, and the like). The data is collected and stored in a user profile, such as a profile memory (not shown). The profiles of the client can contain client characteristic data that includes information collected over the any number of data bases. The risk assessment component 306 is operable to determine a credit worthiness score based on external data in combination with the financial score determined from the set of financial interactions analyzed by the computer device, or, in other words, the networked system discussed herein.

The risk assessment component 306 is further configured to assess a risk level based on the communication for a third party to assess and/or for the user to assess his or her own behavior and risk tolerance indicator. The financial scoring component 208 can generate a financial score based on the facilitated financial interaction in accordance with various embodiments. The computing device 302 is configured to receive a set of inputs based on the financial interaction, the set of inputs including at least one of a voice input, a text input, or a selection input received during the financial interaction that is analyzed for media content to correspond with certain key indicators, such as actions, words or phrases related to a set of behaviors. The computing device 302 can include one or more mechanisms in addition to a touch panel that permit a user to input information thereto, such as microphone, keypad, control buttons, a keyboard, a gesture-based device, an optical character recognition (OCR) based mechanism, a joystick, a virtual keyboard, a speech-to-text engine, a mouse, a pen, and/or voice recognition and the like. The client (or user) can input selections or options to follow according to the recommendations provided, such as to set up a savings account, auto pay, and/or other financial options that are presented to the client device 102, and can input preferences for voice tone, gender, dialect, language, phrase construction, etc.

The reward stimulus component 308 is configured to generate a reward stimulus in response to a financial measure. For example, as a financial measure such as a financial score determined by the scoring component 208 is increased a reward or stimulus can be provided in the form of a positive remark made by the interaction component 116 as encouragement, educational remarks to reinforce behavior and further improving the financial measure in the future, a credit offer can be made via the interaction component and a third party financial institution, bank or investment center, a lower interest rate could be offered, a flexible payment structure and/or another financial offer. These rewards and/or stimulus to the user via the reward stimulus component 308 can be based on conversational dialogue or exchange with the user, additional conversations related to a particular subject matter (e.g., financial assessment data), behavioral data, and/or personal data analytics.

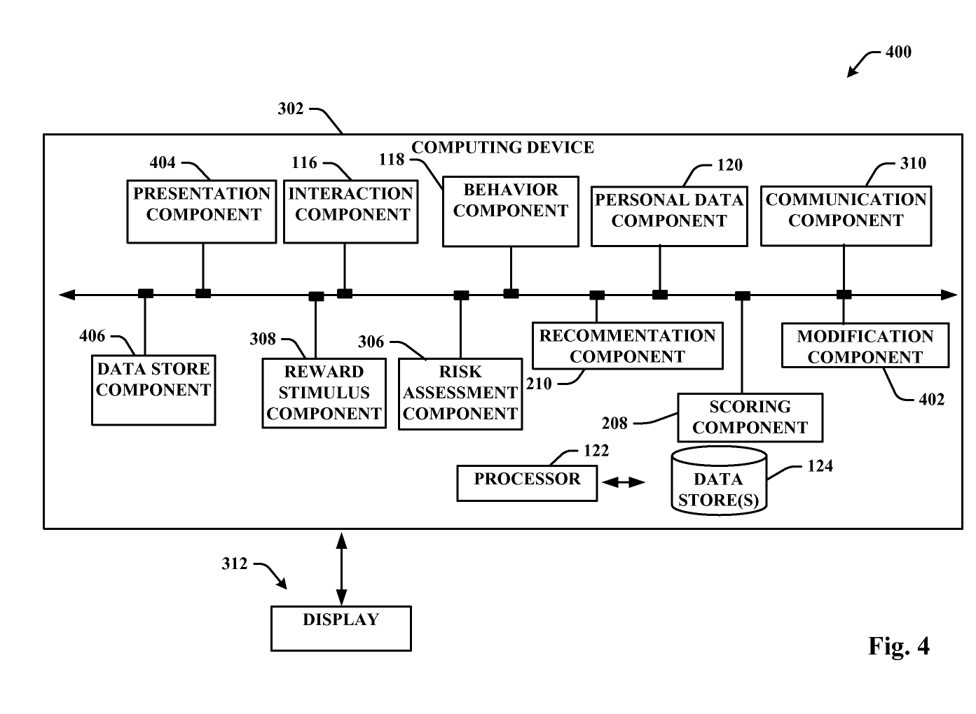

Referring now to FIG. 4, illustrated is a system 400 with the computing device for a personal companion in accordance with various embodiments described herein. The computing device 302 further includes, for example, a modification component 402, a presentation component 404 and a data store component 406.

The modification component 402 is configured to modify at least one of the user preferences of a user profile 206 according to an updated personal data analytic and/or an updated financial behavioral data throughout continued conversations with a user. The user preferences can include a tone (e.g., a voice tone, a text tone, etc.), a phrase, a language (e.g., English, Russian, etc.) a dialect (e.g., a regional accent, grammar construction, etc.) and/or a grammar construction. The modification component 402 can alter the user preferences, for example, according to the user's usage of language, dialect, etc. dynamically by receiving one or more inputs from the user that the modification component detects and/or detects from the voice input and/or other inputs received from a user during the course of conversational dialogue.

For example, a user could communicate with a southern accent from a geographical location or a global positioning system location, in which the modification component 310 can detect the variances and adapt to have a similar dialect and/or grammar construction as the user. Additionally or alternatively, the modification component 402 can receive inputs via a selection input from a user to predetermine the user preferences used by the computing device 302 for conversation. A tone, for example, can include a voice level or a type of voice used (e.g., according to a gender, an age, deep vocal tones, soft vocal tones, and the like) in order to more personalize communications. Different dialects can utilize different vocal tones, different grammar usages, phrases and the like, which can also be selected, and/or detected to be dynamically modified to accommodate the user and detect a set of inputs or conversations exchanged with or by the user.

The presentation component 404 is configured to facilitate a display of a financial measure and alter the displayed financial measure based on a change in at least one of the personal data analytics and/or the set of financial behavioral data determined. For example, the presentation component 404 is configured to display a financial score including a plurality of financial indicators that include at least one of a financial credit score number or a financial credit grade. A number of scoring indications are envisioned, such as a letter grade, a number (e.g., a credit risk number with the highest number being about 850 and the lowest being about 300, and/or any other number range), as well as quality indications that can be illustrated according to colors (e.g., red different shades to black).

The presentation component 404 is further configured to display a chronology of the plurality of financial/key indicators that are calculated during the financial interaction. For example, a series of behaviors over time, which can be in connection with recommendations, suggestions or advice from questions, scenarios and/or statements can be generated to dialogue with a client device and/or via the communication component 310. In addition, each interaction in the series can be generated with time lines along with the financial scores at each of the time lines. As scores are altered, and/or updated, the presentation component 404 can display or communicate dynamically an updated score to the display 312, user and/or a client device.

The data store component 406 operates to search and identify personal data analytics, profile data, financial behavioral data, and/or user preferences from one or more data stores, such as the data store 124, an external data store, a network server, cloud server, a public data store, private data store and/or other data store in communication with the data store component 406. For example, the data store component 406 can access a social network for the retrieval of personal analytic data (e.g., personal data) to determine personal information about a user. In addition, the data store component 406 can access a user's bank information if provided authentication or authorization to track and/or obtain spending or additional financial information about the user and/or the user's financial behaviors.

The interaction component 116 is configured to operate in conjunction to transmit and receive at least one of textual dialogue, voice dialogue, video content or image content related to the financial interaction. For example, a user can view various selections, questions, statements, options, scenarios of financial situations, conditions and the like, chat with a live representative, view recommendations or financial advice tips during the interactive financial dialogue generated by the recommendation component 210, and interact with the user or a user device to further facilitate communication about a set of circumstances (a transaction being conducted, a financial application for credit, a change in behavior related to at least one of savings, spending, money deposits, expenses, and/or the like). A chat session can also be generated that responds dynamically to a user with artificial intelligence logic, such as rule based logic, fuzzy logic and/or other artificial intelligence design. For example, a user can respond with concerns about saving money, and the system could focus questions, scenarios, and the like to generate data used in order to measure or rate the user's behavior and/or how a credit score would correspond via the scoring component 208.

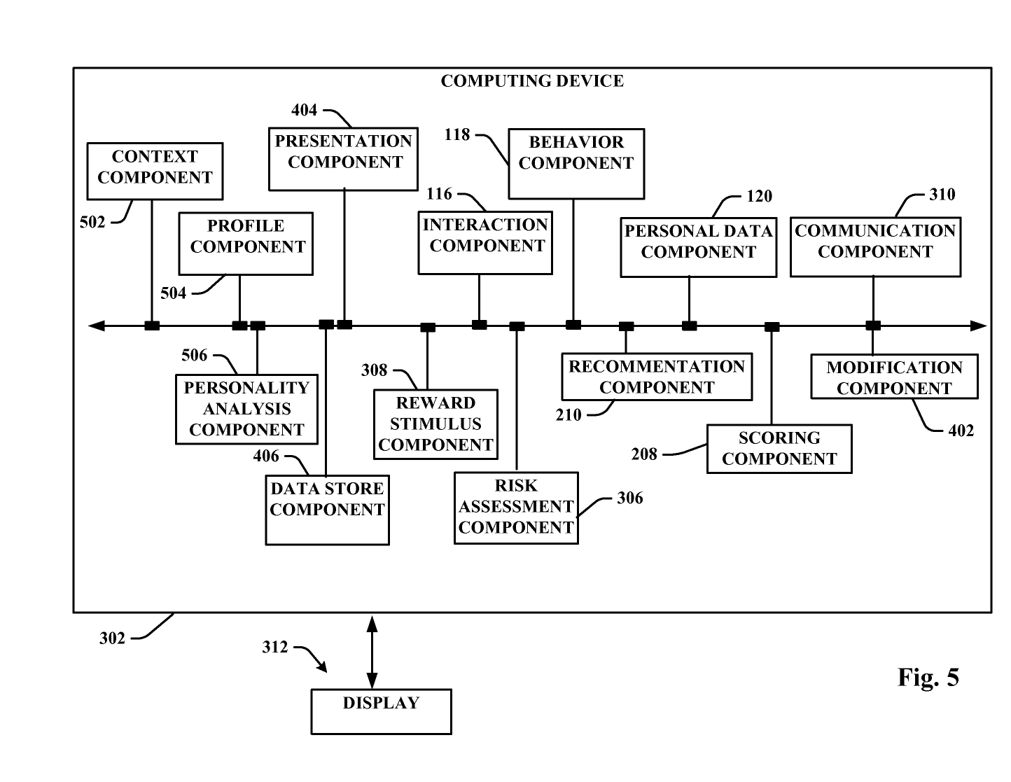

Referring now to FIG. 5, illustrated is another example of a system with the computing device 302 in accordance with various embodiments described herein. For example, the computing device 302 operates to collect and respond to information about a user via client devices, networks, data store(s), a bank aggregate data store, user profiles, communication with the user via the communication component 310, and/or financial transactions or other transactions. The computing device further includes a context component 502, a profile component 504, and a personality analysis component 506.

The context component 502 is configured to determine contextual information to further aid in determining how to communicate with a user. For example, a geolocation information can be obtained (e.g., a Global Positioning System location, travel itinerary data, inputted data, and the like) in order to ascertain the location of the device 302 and/or the user that the device is in communication with for continuous dialoguing. Additionally, recent payment activity, electronic interactions with social media and/or electronic conversations (email, chat, etc.) can be analyzed and identified by the context component for communication to other components of the system. The interaction component 116 is further able to identify dialogue statements, questions, and/or communicate with a user based on his or her context or environment.

For example, a user could be present with the computing device (e.g., personal mobile device) and be able to recommend via the recommendation component 210 an exchange rate that could change from one time to another that is determined to be better than a previous one. Additionally, one currency exchange center could provide a better exchange rate than another, which the computing device 302 could use the context information from the context component 502 to initiate conversation with the user this information. In another example, a user could be traveling with the computing device 302 and communicate with the automobile's computer to determine that fuel is low. The computing device 302 could access a network and/or a personal data store to determine the most recent data regarding gasoline or fuel prices that are the best or lowest and are nearest to the user.

The system further includes the profile component 504 that is configured to generate a user profile that includes one or more psychological classifications, financial data, a level financial knowledge rated to be associated with the client. For example, the communications with the client can include various questions that operate to determine a psychological profile of the client. One example of such questions could be from a Myer's Briggs Test, or other such testing questions. A psychological profile can then be generated that could determine a rating for impulsivity, loyalty, tolerance for risk, and other such behavioral characteristics. In addition, the profile component can include information about the user's level of financial knowledge such as on investment opportunities with a bank, money saving options, credit options, and/or other financially related data about a client. The profile component 504 operates to general a broad user profile that is dynamically updated throughout interactions with the client via the computing device 302, in which communications with the client can be tailored to according to voice, tone, expressions (phrases used) and the like. This enables the computing system 302 to operate as a dynamic, friendly financial companion according to the user profile that is generated dynamically or in real time.

The profile component 504 is operable to generate a profile related to a certain client from interactions with the client and store the data in the user profile, for example. The financial profile component 504 is configured to retrieve a set of search results from data sources in response to a search query, which can be a credit score, a credit history, such as a credit report from a public or private data base. The financial profile component 504 is configured to generate the client profile with metadata (e.g., attributes or characteristics) associated with the client and to rank the metadata according to a level of validity and/or relevance to the client. Characteristics or attributes are assimilated as metadata associated with the client profile in storage, for example, and can be from data sources that can include virtually any open source or publicly available sources of information, as well as private sources, including, but not limited to websites, search engine results, social networking websites, online resume databases, job boards, government records, online groups, payment processing services, online subscriptions, and so forth. In addition, the data sources can include private databases, such as credit reports, loan applications, and so forth.

The personality analysis component 506 is configured to determine user preferences dynamically by updating personal data analytics about the user. For example, as a user responds in a certain tone, the personality analysis component 506 can identify the user's vocal tone and response according to a different tone to the user than in a previous conversation with the same user. Other user preferences can also be modified, such as with a dialect or sentence phrases (e.g., slang, different levels of sophistication, etc.) as different moods, catch phrases, taste and/or habits (e.g., enjoys one thing over another) of the user are detected.

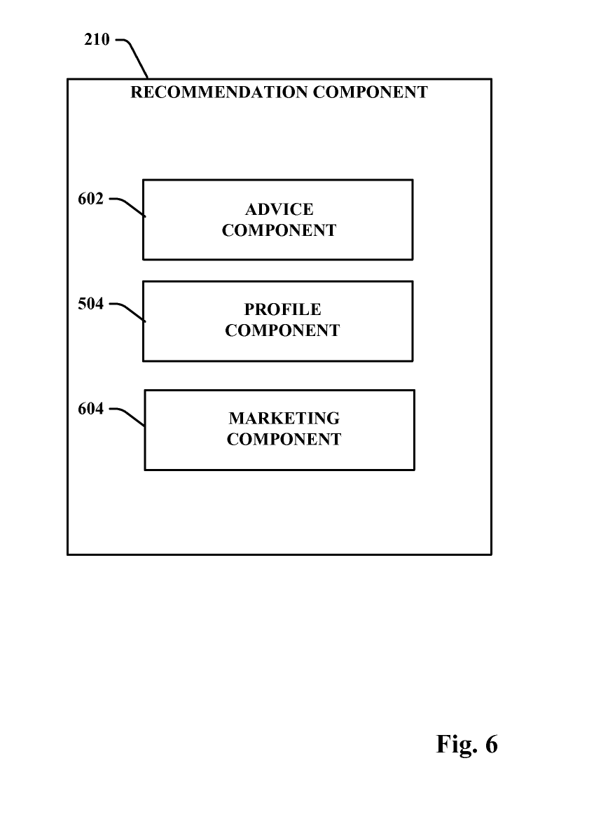

Referring now to FIG. 6, illustrated is an example recommendation component 210 in accordance with various embodiments described. The recommendation component can include an advice component 602, the profile component 504 (discussed above) that communicates further advice related to the behavior determined during the financial interactions. For example, various warnings, tips, hints, suggestions and/or recommendations can be generated to a user based on behavioral responses received, personal data analytics, behavioral data, and/or user preferences.

The advice component 502 and the financial profile component 504 are communicatively coupled to a marketing component 506. Based on predetermined criteria such as information obtained from official data sources and information obtained from publicly available data sources, the marketing component 506 can output recommendations for providing credit, a loan or other financial instrument to a client, such as via a marketing plan or strategy. For example, where a life experience can make one marketing strategy for a loan discouraging to a client, another strategy could be used to portray financial instruments in a better light. Rather than only basing recommendations on financial data, the marketing component 506 determines recommendation on publicly available data such as the interest, abilities, skills, temperament, associations and character aspects of the client, for example.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

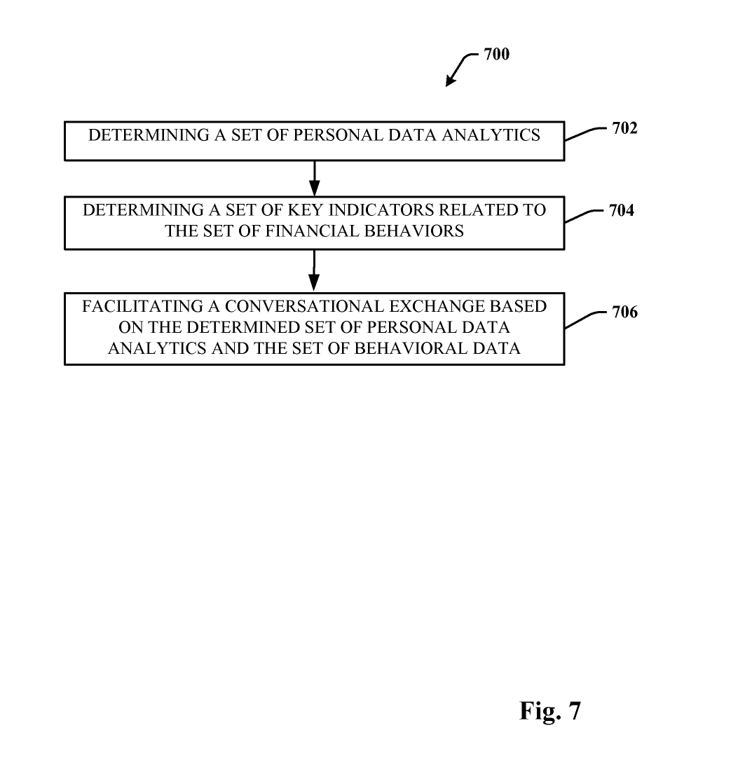

FIG. 7 illustrates a method 700 for generating an interactive conversation with a client device based on information learned from inputs received and/or retrieved from various data stores. At 702 a set of personal data analytics is determined. For example, data from various data stores, communication with via client device (e.g., vocal communication, electronic messages, chat, etc.), social networks, banking aggregates, digital wallet, etc. can be analyzed to determined information about a user, a user's habits, financial knowledge, financial conditions, financial habits, spending patterns, saving behaviors, investment strategy and the like. In one example, the set of personal data analytics can be determined from inputs received from a conversational dialogue initiated by an interaction component of a mobile device as well as from personal data identified from a data store.

At 704, a set of behavioral data is determined based on one or more financial transactions. For example, from online purchases and other transactional information can be identified to determine spending habits. Other transactions can also be used to determine a financial condition of the user's accounts, savings, income and other financially related information.

At 706, a conversational exchange is facilitated based the determined set of personal data analytics and the set of behavioral data. The conversational exchange can include selecting an expression to communicate based on the set of user preferences and a set of contextual information comprising a geolocation, a recent financial activity, an electronic interaction identified with social media, an electronic transaction, a voice communication, or electronic communication.

In one embodiment, the method 700 can further include determining a set of user preferences and modifying the set of user preferences for facilitation of the conversational exchange. The set of user preferences can comprise a voice tone, a gender tone, a dialect, and a language.

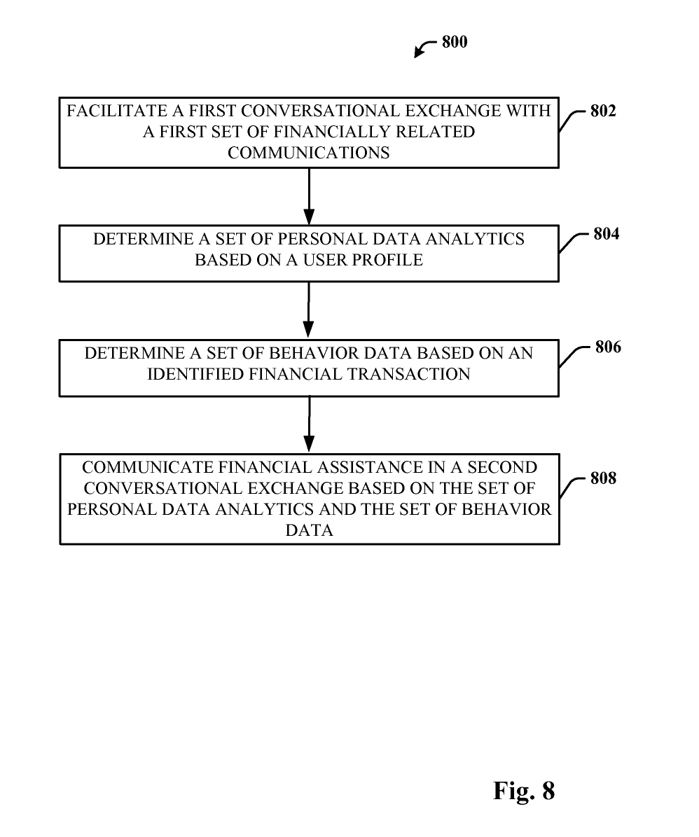

FIG. 8 illustrates an example methodology 800 for generating conversational dialogue with a user of client device in accordance with various embodiments described herein. The method initiates at 802 by facilitating a first conversational exchange with a first set of financially related communications.

At 804, a set of personal data analytics is determined based on a user profile. At 806, the method 800 further includes determining a set of behavior data based on an identified financial transaction. At 808, financial assistance is communicated in a second conversational exchange based on the set of personal data analytics and the set of behavior data. For example, financial recommendations, questions, and/or statements can be generated to further aid a user in their financial condition and provide options for bettering the financial knowledge of the user, such as by a reward and/or stimulus (e.g., better credit rating, credit opportunities, credit availability and the like).

In one example, the personal profile can comprise a set of user classifications that categorize a user personality based on personal data, and wherein the personal data analytics comprise information about predicted financial behaviors that correspond to the user profile. For example, personal or user classifications can be personality types and/or traits, such as being a duty fulfiller, a mechanic, a nurturer, an artist, a protector, a thinker, a doer, a giver, and/or various aptitudes that can be used to assess a client and to communicate in mannerisms and content that are more identifiable or trusting of a client.

In one embodiment, the first initiated conversational exchange can be based on only personal data collected. The second set of communications could be based on personal data as well as behavior data that is observed to further provide assistance in a manner that is conducive to the user and would more likely elicit a positive response or further communication with a dynamic digital assistant.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

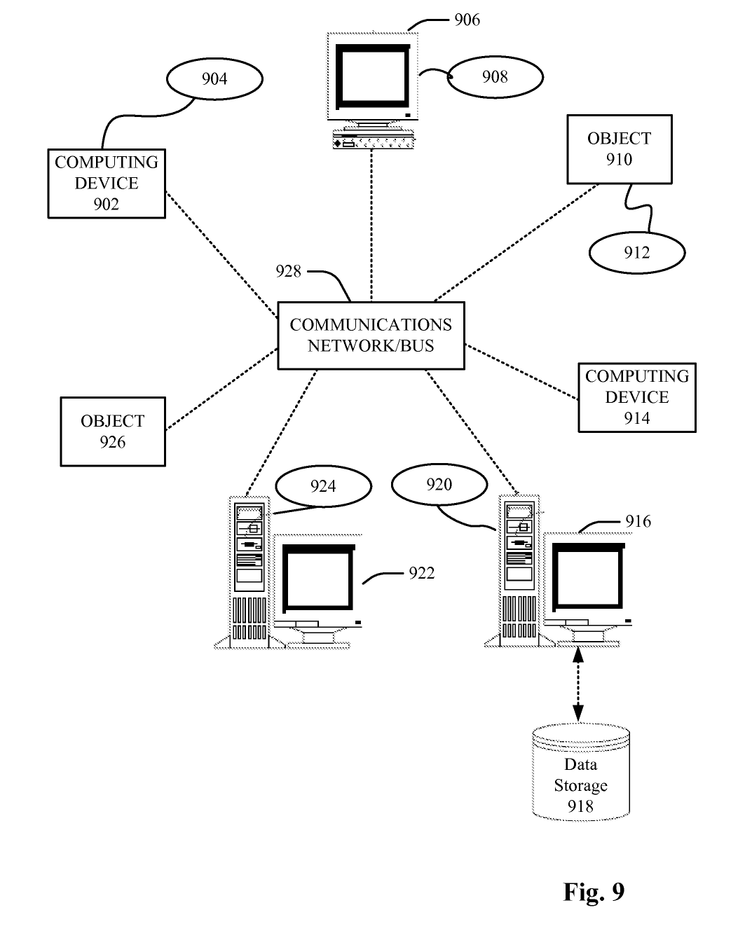

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

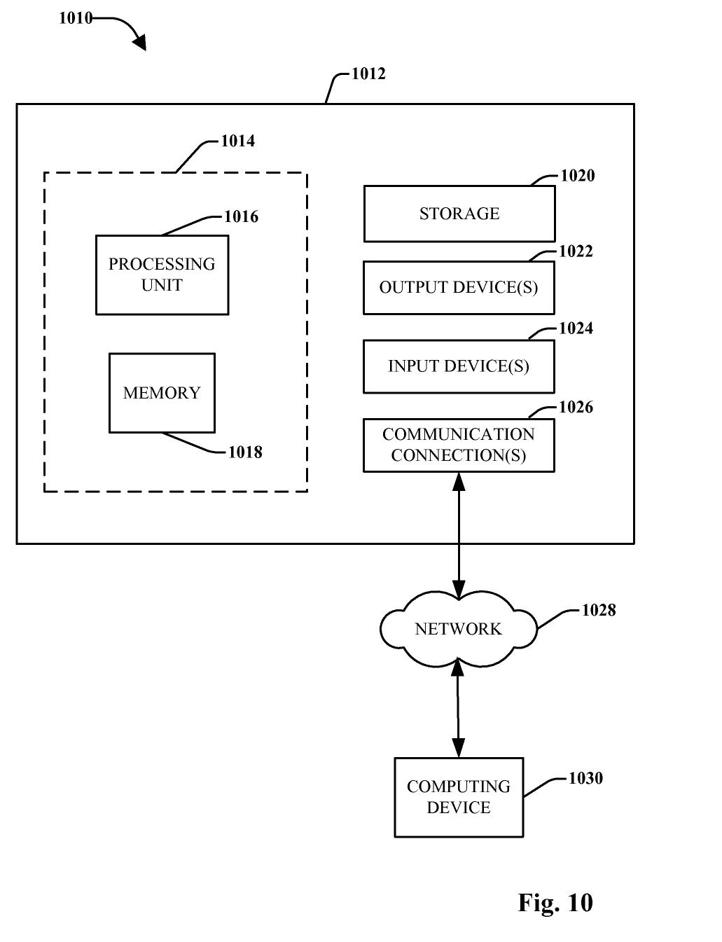

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1010.

Device 1012 may also include communication connection(s) 1026 that allows device 1010 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1010. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system, comprising:
a memory that stores computer-executable components; and
a processor, communicatively coupled to the memory, that facilitates execution of the computer-executable components, the computer-executable components comprising:
an interaction component configured to facilitate a communication related to modifying a financial behavior, wherein the communication is based on a set of personal data analytics and a set of financial behavioral data;
a personal data component configured to determine the set of personal data analytics based on a set of inputs that relate to financial data identified at a user device; and
a behavior component configured to determine the set of financial behavioral data based on a set of financial transactions for determining the financial behavior.

2. The system of claim 1, wherein the computer-executable components further comprise:
a communication component configured to initiate at least a part of the communication that relates to the financial data via a voice communication.

3. The system of claim 1, wherein the computer-executable components further comprise:
a personality analysis component configured to determine a set of user preferences based on the set of personal data analytics and modify the set of user preferences for facilitation of the communication.

4. The system of claim 3, wherein the interaction component is further configured to facilitate the communication based on the set of user preferences that comprise at least one of a tone, a gender, a dialect, a language, or a grammar construction.

5. The system of claim 1, wherein the computer-executable components further comprise:
a scoring component configured to generate a financial measure from the communication based on the set of personal data analytics and the set of financial behavioral data.

6. The system of claim 5, wherein the computer-executable components further comprise:
a presentation component configured to facilitate display of the financial measure and alter the displayed financial measure from the communication based on a change in at least one of the set of personal data analytics or the set of financial behavioral data.

7. The system of claim 1, wherein the computer-executable components further comprise:
a data store component configured to search and identify the set of personal data analytics and the set of financial behavioral data from one or more data stores.

8. The system of claim 1, wherein the set of financial behavioral data based on the set of financial transactions comprises at least one of payment patterns, debt accumulation data, expense data, income data or interest rate data from the financial transaction or one or more data stores comprising the set of financial behavioral data based on the set of financial transactions.

9. The system of claim 1, wherein the computer-executable components further comprise:
a profile component configured to generate a user profile that comprises at least one of a psychological classification, financial data, or a level of financial knowledge for the communication.

10. The system of claim 9, wherein the set of personal data analytics comprises at least one of data from the user profile, conversational data obtained from the communication, or public data related to financial information.

11. The system of claim 1, wherein the computer-executable components further comprise:
a context component configured to determine contextual information for the communication based on geolocation or global positioning system location, recent payment activity, electronic interaction with social media or electronic conversations.

12. The system of claim 1, wherein the personal data component and the behavior component are further configured to determine the set of personal data analytics and the set of financial behavior data respectively based on at least one of banking information, public and private network information, the conversation, or from a set of inquiries.

13. The system of claim 1, wherein the computer-executable components further comprise:
a recommendation component configured to generate a set of recommendations related to improving a financial measure a based on communication responses received as the set of inputs during the communication, the set of personal data analytics and the set of financial behavior data.

14. The system of claim 1, wherein the computer-executable components further comprise:
a reward stimulus component configured to generate reward stimulus in response to a financial measure satisfying a predetermined threshold based on the set of financial behavioral data, wherein the reward stimulus comprises at least one of positive remarks, further education to improving the financial measure, a credit offer, a lower interest rate, a flexible payment structure or a financial offer.

15. The system of claim 14, wherein the computer-executable components further comprise:
a risk assessment component configured to assess the financial measure comprising a risk level based on the communication and the set of financial behavioral data.

16. The system of claim 1, wherein the interaction component is further configured to initiate the communication that comprises a financial interaction based on a set of financial behavioral options comprising at least one of a suggested financial option, data gathering options, financial questions or a financial communication based on an updated financial condition.

17. The system of claim 1, wherein the computer-executable components further comprise:
a communication component configured to receive the set of inputs, and communicate the communication in a format that comprises at least one of an audio voice format, a text based message format, or a video format.

18. The system of claim 1, wherein the computer-executable components further comprise:
a modification component configured to modify at least one of a tone, a phrase, a language, a dialect, or a grammar construction according to an updated personal data analytic or an updated financial behavioral data.

19. An apparatus, comprising:
a memory to store computer-executable instructions; and
a processor, communicatively coupled to the memory, that facilitates execution of the computer-executable instructions to at least:
facilitate a conversational dialogue by communicating a first set of communications;
determine a set of personal data analytics based on a set of inputs received from the conversational dialogue that relate to communicated personal data or personal data identified from a data store;
determine a set of behavioral data based on a transaction or exchange of assets detected; and
communicate a second set of communications for the conversational dialogue based on at least one of the set of personal data analytics or the set of behavioral data.

20. The apparatus of claim 19, wherein the processor further facilitates execution of the computer-executable instructions to communicate at least a part of the first set of communications to initiate communication of the set of inputs that relate to personal financial data via at least one of a voice communication, a text based communication, or a video communication.

21. The apparatus of claim 20, wherein the first set of communications comprise predetermined options for generating the conversational dialogue.

22. The apparatus of claim 21, wherein the processor further facilitates execution of the computer-executable instructions to:
modify the first set of communications communicated based on an updated behavioral data determined or an updated personal data analytic determined; or
modify the second set of communications communicated based on the updated behavioral data or the updated personal data analytic.

23. The apparatus of claim 19, wherein the processor further facilitates execution of the computer-executable instructions to determine a set of user preferences based on the set of personal data analytics and modify a communication of the first set of communications or the second set of communications based on the set of user preferences.

24. The apparatus of claim 23, wherein the set of user preferences comprise at least one of a tone, a gender, a dialect, a language, or a grammar construction.

25. The apparatus of claim 19, wherein the processor further facilitates execution of the computer-executable instructions to generate a financial measure that comprises a score based on the conversational dialogue.

26. The apparatus of claim 19, wherein the second set of communications comprises a communication based on the set of personal data analytics and the set of behavioral data.

27. The apparatus of claim 19, wherein the processor further facilitates execution of the computer-executable instructions to identify the set of personal data analytics and the set of financial behavioral data from one or more data stores comprising at least one of a telecommunications data store, a bank data store, a social network data store, a survey data store having survey or questionnaire responses assessing a psychological profile, or a conversation data store having conversation data stored from one or more past conversational dialogues generated.

28. The apparatus of claim 19, wherein the second set of communications comprises at least one of a payments option, a payment plan, a financial assistance option, a financial recommendation, a financial savings option, or an investment option, that is communicated according to a set of user preferences.

29. The apparatus of claim 28, wherein the first set of communications comprises a communication that comprises at least one of a question, an observational statement, or a request, that communicated according to a set of user preferences.

30. The apparatus of claim 29, wherein the processor further facilitates execution of the computer-executable instructions to modify at least one of the set of user preferences comprising at least one of a tone, a phrase, a language, a dialect, or a grammar construction according to an updated personal data analytic or an updated financial behavioral data.

31. The apparatus of claim 29, wherein the processor further facilitates execution of the computer-executable instructions to modify at least one of the set of user preferences comprising at least one of a tone, a phrase, a language, a dialect, or a grammar construction based on a set of contextual information for the conversational dialogue that comprises at least one of a geolocation, a recent financial activity, an electronic interaction identified with social media, an electronic transaction, a voice communication, or electronic communication.

32. The apparatus of claim 19, wherein the processor further facilitates execution of the computer-executable instructions to assess a risk level that comprises a financial risk based on the conversational dialogue.

33. The apparatus of claim 19, wherein the processor further facilitates execution of the computer-executable instructions to:
generate a user profile that comprises at least one of a psychological classification for determining a tone, a phrase, a language, a dialect, or a grammar construction as a set of user preferences,
wherein the first set of communications and the second set of communications are respectively based on the user profile, the determined set of behavioral data and the determined set of personal data analytics.

34. The apparatus of claim 19, wherein the processor further facilitates execution of the computer-executable instructions to generate a reward stimulus in response to a financial measure increasing based on the conversational dialogue or additional conversations related to financial data related to the set of behavioral data and the set of personal data analytics, wherein the reward stimulus comprises at least one of positive remarks, further education to improving the financial measure, a credit offer, a lower interest rate, a flexible payment structure or a financial offer.

35. A method comprising:
determining, by a system comprising at least one processor, a set of personal data analytics;
determining a set of behavioral data based on one or more financial transactions; and
facilitating a conversational exchange based on the determined set of personal data analytics and the set of behavioral data.

36. The method of claim 35, further comprising:
determining the set of personal data analytics from an input received of an initial conversational dialogue initiated by an interaction component of a mobile device and personal data identified from a data store.

37. The method of claim 35, further comprising:
determining a set of user preferences and modifying the set of user preferences for facilitation of the conversational exchange, wherein the set of user preferences comprise a voice tone, a gender tone, a dialect, and a language.

38. The method of claim 37, further comprising:
selecting an expression to communicate for the conversational exchange based on the set of user preferences and a set of contextual information comprising a geolocation, a recent financial activity, an electronic interaction identified with social media, an electronic transaction, a voice communication, or electronic communication.

39. The method of claim 35, further comprising:
generating a financial measure from the conversational exchange based on the set of personal data analytics and the set of financial behavioral data.

40. The method of claim 35, further comprising:
generating a reward stimulus in response to a financial measure that is based on the conversational exchange or additional conversations related to financial data related to the set of behavioral data and the set of personal data analytics, wherein the reward stimulus comprises at least one of positive remarks, further education to improving the financial measure, a credit offer, a lower interest rate, a flexible payment structure or a financial offer.

41. The method of claim 35, further comprising:
assessing a financial risk level based on the conversational exchange and modifying a set of communications to communicate in the conversational exchange based on the financial risk level.

42. The method of claim 35, further comprising:
identifying the set of personal data analytics and the set of financial behavioral data from one or more data stores comprising at least one of a telecommunications data store, a bank data store, a social network data store, a survey data store having survey or questionnaire responses assessing a psychological profile, or a conversation data store having conversation data stored from one or more past conversational exchanges generated.

43. The method of claim 35, wherein the set of personal data analytics comprises data related to a user profile having personal data about a client and the financial behavioral data comprises data about a transaction conducted by the client.

44. A tangible computer readable storage medium comprising computer executable instructions that, in response to execution, cause a computing system comprising a processor to perform operations, comprising:
facilitating a first conversational exchange with a first set of financially related communications;
determining a set of personal data analytics based on a user profile;
determining a set of behavior data based on an identified financial transaction; and
communicating financial assistance in a second conversational exchange based on the set of personal data analytics and the set of behavior data.

45. The tangible computer readable storage medium of claim 44, wherein the personal profile comprises a set of user classifications that categorize a user personality based on personal data, and wherein the personal data analytics comprise information about predicted financial behaviors that correspond to the user profile.

46. The tangible computer readable storage medium of claim 45, wherein the communicated financial assistance comprises at least one of a recommendation, a question, a statement, an option, or a request, that are based on at least one of a financial goal, a spending behavior, a loan request, or a financial saving behavior.

47. The tangible computer readable storage medium of claim 46, the operations further comprising:
determining a set of user preferences based on the set of personal data analytics and modifying the communication in the first conversation exchange or the second conversational exchange.

48. The tangible computer readable storage medium of claim 45, wherein the first conversational exchange initiates a communication related to personal finances with a mobile device.

49. The tangible computer readable storage medium of claim 47, the operations further comprising:
generating a financial measure that comprises a score based on the conversational dialogue; and
presenting the score in a display for viewing.

50. The tangible computer readable storage medium of claim 47, the operations further comprising:
modifying at least one of the set of user preferences used to communicated in the first conversational exchange or the second conversational exchange comprising at least one of a tone, a phrase, a language, a dialect, or a grammar construction based on a set of contextual information for the conversational dialogue that comprises at least one of a geolocation, a recent financial activity, an electronic interaction identified with social media, an electronic transaction, a voice communication, or electronic communication.

51. The tangible computer readable storage medium of claim 47, the operations further comprising:
generating a reward stimulus in response to a financial measure increasing based on the conversational dialogue or additional conversations related to financial data related to the set of behavioral data and the set of personal data analytics, wherein the reward stimulus comprises at least one of positive remarks, further education to improving the financial measure, a credit offer, a lower interest rate, a flexible payment structure or a financial offer.
